(19) United States
(12) Patent Application Publication
(10) Pub. No.: US 2007/0267115 A1
(43) Pub. Date: Nov. 22, 2007

(54) Pneumatic tire with decoupling groove

(75) Inventor: Daniel Stephen Mathews, Mount Vernon, IL (US)

Correspondence Address: CONTINENTAL TEVES, INC., ONE CONTINENTAL DRIVE, AUBURN HILLLS, MI, 48326-1581, US

(73) Assignee: Continental Tire North America, Inc.

(21) Appl. No.: 11/437,120

(22) Filed: May 18, 2006

(51) Int. Cl. B60C 11/01; B60C 11/03

(52) U.S. Cl. 152/209.15; 152/209.16

(57) ABSTRACT

A tire tread has a decoupling groove (18) with an opening angle (α) of approximately 15°. Even if gravel is moved into the groove (18) by the decoupler rib (14), it will easily fall out once the tread section loses touch with the road surface and the groove (18) expands to its relaxed shape.

Additionally, the ridge (24) of the decoupler rib (14) is rounded with a radius (R2) of about 2 mm. By this means, it has a much lower tendency to pick up rocks by scooping when bending toward the shoulder rib (16).

A rounded bottom of the decoupling groove (18) with a radius (R1) of approximately 1.5 mm, will prevent any rocks from wedging into the bottom of the decoupling groove (18).

### BACKGROUND OF THE INVENTION

The present invention relates to a tire tread with a circumferential decoupling groove as commonly used on truck steer tires or on other non-drives axles, for instance on trailers.

The use of treads specifically designed for the steer axle of truck tires has been directed to various forms of rib-type tires. This non-driving axle exhibits cornering and turning loads as well as straight line running loads.

High wear erosion is common in the shoulder region of the tread. In order to reduce irregular wear, the use of a laterally located circumferentially continuous rib, a so-called decoupler rib, has been suggested that under normal driving conditions is in contact with the road, the force or pressure exerted by the decoupler rib on the road being less than the force or pressure of the shoulder rib. Such a tire profile is shown in FIG. 4. This kind of tire 2 relies on the decoupler rib 4 to protect the sharp edge of the shoulder rib 6. This slightly recessed decoupler rib 4 as shown in FIG. 4 is to be in contact with the road surfaces when in normal running conditions, the decoupler rib 4 exhibiting less pressure than shoulder rib 6. The decoupling groove 8 separating the decoupler rib 4 from the shoulder rib 6 has nearly parallel walls leading up to the edge of the shoulder rib 6 on the one hand and to the edge of the decoupler rib 4 on the other hand. The profile of the decoupler rib 4 has a ridge with an acute angle that provides a rather pointy edge One such tire 2 is believed to be the Goodyear G397 LHS steer tire.

A similar decoupler rib has been suggested in U.S. Pat. No. 5,550,652 with the difference that the radially shorter decoupler rib will not make contact with the road under normal driving conditions.

While this type of tire tread provides excellent properties while working as intended, one common problem is that small rocks and gravel become lodged in the decoupling groove. The sharp edge of the decoupler rib 4 moves toward the wall 10 of the decoupling groove 8 when the corresponding section of the tire tread is under load, thus scooping small rocks into the groove. The groove itself, due to its elasticity and shape, will hold the rocks in place. This inhibits the proper function of the decoupler rib, which cannot bend toward the shoulder rib 6 any more and thus becomes ineffective in preventing irregular wear on the shoulder rib 6.

It is therefore the objective of the present invention to provide a tire tread with a decoupling groove and a decoupler rib which reduces the risk of rocks and gravel being caught in the decoupling groove.

### SUMMARY OF THE INVENTION

This objective is achieved by a tire tread with a decoupling groove having an opening angle of at least 12°, preferably 14°-20°. Even if gravel is moved into the groove by the decoupler rib, it will easily fall out once the tread section loses touch with the road surface and the groove expands to its relaxed shape.

Additionally, the ridge of the decoupler rib, which has previously had a rather sharp edge, can be rounded with a radius of at least 1.5 mm, preferably 1.8 mm to 2.5 mm. By this means, it has a much lower tendency to pick up rocks by scooping when bending toward the shoulder rib.

Thirdly, a rounded bottom of the decoupling groove with a radius of at least 1 mm, preferably 1.4 mm to 2 mm, will prevent any rocks from wedging into the bottom of the decoupling groove.

Further details will be evident from the following description of an embodiment by hand of three drawings.

### BRIEF DESCRIPTION OF THE DRAWINGS

In the drawings,

FIG. 1 is a schematic cross-sectional partial view of a tire according to the present invention.

FIG. 2 is an outline of a portion of the tire tread illustrating the dimensions.

FIG. 3 is a dimensional view of the portion illustrated in FIG. 2.

FIG. 4 is an illustration of a prior art tire showing the portion corresponding to FIGS. 2 and 3.

### DETAILED DESCRIPTION OF THE DRAWINGS

With reference to FIG. 1, a partial radial cross section of the pneumatic radial tire, for example for use on steering axles or trailer axles, is illustrated.

The tire tread 12 comprises a shoulder rib 16 extending in the circumferential direction of the tire and a decoupler rib 14 extending in parallel thereto, separated from each other by a decoupling groove 18. The wall 20 connecting the decoupling groove 18 with the shoulder rib 16 is approximately twice as high as the wall 22 connecting the decoupling groove 18 with the decoupler rib 14. Accordingly, the ridge 24 of the decoupler rib 14 is radially recessed in comparison with the shoulder rib 14. During normal driving conditions, the decoupler rib is not in contact with the road. However, the invention is not limited to this arrangement and also extends to tires with decoupler ribs contacting the road surface.

All other elements of the tire, including the belts 26, are only shown for illustrative purposes and may be arranged differently in an actual tire.

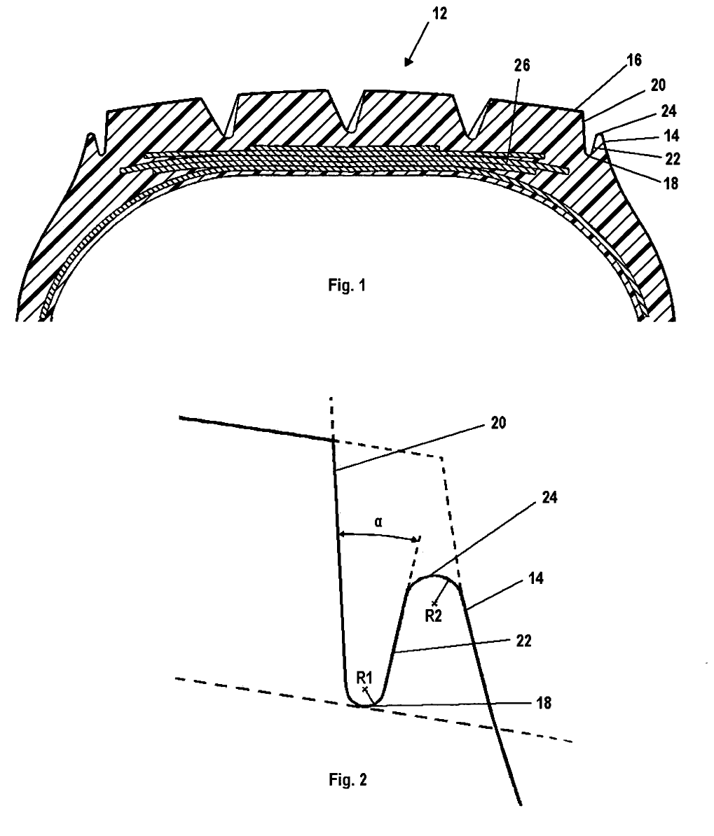

It is evident from FIG. 2 that the walls 20 and 22 are arranged in a wider angle α than known from prior-art tires. In the shown embodiment, this angle between the walls 20 and 22 is approximately 15°. The bottom of the decoupling groove 18 is rounded with a radius R1 of approximately 1.5 mm. the ridge 24 of the decoupler rib 14 is radiused as well. Here, the radius R2 amounts to approximately 2 mm.

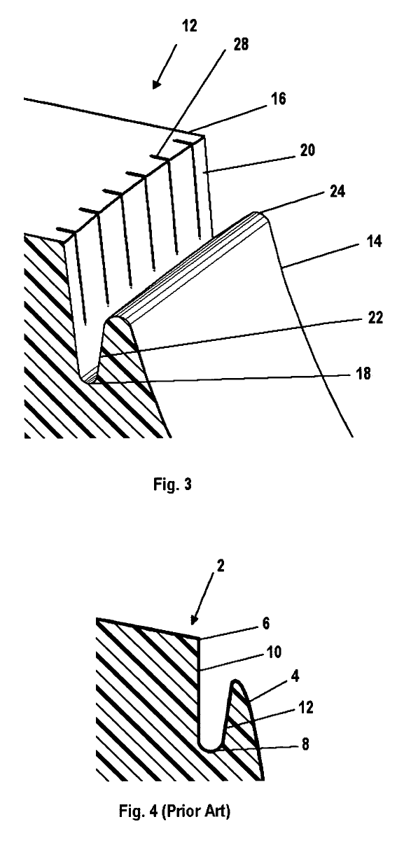

In FIG. 3, basically the same section as in FIG. 2 is shown in perspective as a partial cross-section of the tire tread 12.

The decoupler rib 14 with its radiused ridge 24 is connected to the decoupling groove 18 through the wall 22, which is arrange in an angle with respect to the wall 20 between the decoupling groove 18 and the shoulder rib 16.

The shoulder rib 16 comprises sipes for increased traction. The specific arrangement of sipes in the tire tread 12 is variable and depends on the desired overall tire properties.

What is claimed is:

1. A pneumatic tire with a tread (12) comprising a shoulder rib (16) extending in circumferential direction and separated from a circumferentially extending decoupler rib (14) by means of a decoupling groove (18) with two walls (20,22), one of which (20) connects the decoupling groove (18) with the shoulder rib (16) and the other one of which (22) connect the decoupling groove (18) with the decoupler rib (14), wherein the walls (20,22) are arranged in an angle (α) of no less than approximately 12°, thus widening the decoupling groove (18) in a radially outward direction.

2. The tire according to claim 1, wherein the angle (α) is between 14° and 20°.

3. The tire according to claim 1, wherein the decoupler rib (14) comprises a ridge (24) which is rounded with a radius (R2) of no less than approximately 1.5 mm.

4. The tire according to claim 3, wherein the radius (R2) of the rounded ridge (24) is between 1.8 mm and 2.5 mm

5. The tire according to claim 1, wherein the bottom of the decoupling groove (18) is rounded with a radius (R1) of no less than approximately 1 mm.

6. The tire according to claim 5, wherein the radius (R1) of the bottom of the decoupling groove (18) is between 1.4 mm and 2 mm.

7. The tire according to claim 1, wherein the decoupler rib (14) extends radially to approximately half the height of the shoulder rib (16).
